(19) United States
(12) Patent Application Publication
(10) Pub. No.: US 2013/0325535 A1
(43) Pub. Date: Dec. 5, 2013

(54) SERVICE DESIGN SYSTEM AND METHOD OF USING SAME

(71) Applicant: Majid Iqbal, Rockville, MD (US)

(72) Inventor: Majid Iqbal, Rockville, MD (US)

(21) Appl. No.: 13/906,037

(22) Filed: May 30, 2013

Related U.S. Application Data
(60) Provisional application No. 61/652,894, filed on May 30, 2012.

(51) Int. Cl. G06Q 10/06

(52) U.S. Cl. CPC G06Q 10/067
USPC 705/7.13; 705/348

(57) ABSTRACT

A system for developing a design of a service is provided. The system may include a first canvas including a first plurality of elements that define one or more needs for a service, a second canvas including a second plurality of elements that define a solution that fulfills the one or more needs for the service, and two symmetrical logic loops that relate the first plurality of elements in the first canvas and the second plurality of elements in the second canvas.

This application claims priority to U.S. Provisional Patent Application No. 61/652,894 filed on May 30, 2012, which is incorporated herein by reference in its entirety.

### RELATED ART

Methods and apparatuses consistent with the exemplary embodiments relate to analyzing a need for a service and designing a service to meet the need. In particular, the exemplary embodiments relate to a system and interface to collect and organize information relating to a service and developing a business model to implement the service.

Many businesses and individuals engage in the creation of business models in order to help create successful new businesses as well as to help create new business models for companies that are already in business but need retooling. Business model creation systems according to the related art involve business owners and operators, or outside consultants, who make individual assessments of a business's needs and possible revenue streams. These systems may include a computer-based interface for taking and storing notes related to a business's resources, finances, and possible revenue streams.

However, these related art systems lack a systematic approach to translating and expressing the business model into an actual design that implements it, i.e., the business model itself is necessary but not sufficient for an enterprise and its agents to plan and execute a vision or strategy through a portfolio of products and services to be offered in the market. Business models lack the depth and detail of instructions and specifications necessary for teams and individuals to plan, allocate, organize, configure and deploy the particular capabilities and resources necessary for producing and delivering a product as and when it is demanded by customers in the market. Enterprises in the construction, engineering and manufacturing industries make use of detailed drawings and technical specifications to construct, fabricate, produce and realize products and artifacts they will then sell and distribute in the market. Service enterprises lack similar embodiments and expressions of their designs. Where there are offerings of service design “blueprints,” such offerings are limited to one of process flows, cross-functional diagrams, user interfaces and customer journey maps. While these are useful tools of the trade, they are loosely related and not completely integrated into a single definitive design artifact that encodes the entirety of the design. Business model creation systems themselves do not provide guidance to the system user about the creation of a detailed design artifact and the user is forced to separately rely solely on the skill sets, tools and experiences of others to be able to translate the business model into a design they can implement. These systems rely completely on the creativity, problem-solving and design acumen of the user, who may or may not have any advanced design training and who may or may not be aware of business theories and strategies that are taught at advanced business schools. These systems often rely on personal knowledge and anecdotal evidence, and do not provide the user the ability to compare these newly created business plans with successful business plans and do not provide a means to rate or grade the plan. Because there is no means within the system to get independent review of the business plan, the business plan may suffer from the system user's personal biases and overly optimistic projections for their revenue streams and costs.

Another disadvantage that these related art systems face is that they do not produce the business plans in a standardized computer readable format that may be easily distributed to service providers and other third parties in order for the business owner or operator to solicit proposals and bids from the service providers and third parties that are individually tailored to the business's needs. The lack of a standardized computer readable format also inconveniences service providers by not allowing them to use a format that can be used with their existing proposal planning software and may require them to learn a new computer software system in order to submit a new service proposal.

### SUMMARY

According to an aspect of one or more exemplary embodiments, there is provided a system for developing a design of a service to be provided to a customer or procured from a service provider. The system according to one or more exemplary embodiments may include a first canvas having a plurality of elements that define one or more needs for a service, a second canvas having a plurality of elements that define a solution that fulfills the one or more needs for the service, wherein the elements of the first canvas may be related by a first contiguous logic loop in which one or more elements in the first canvas are inputs to one or more other elements in the first canvas. The elements of the second canvas may be related by a second contiguous logic loop in which one or more elements in the second canvas are inputs to one or more other elements in the second canvas. The first and second contiguous logic loops may be symmetrical with respect to each other.

The elements of the first canvas and the second canvas may each include 16 elements arranged in a 4×4 array. The first contiguous logic loop may begin at an upper left element of the first canvas, and the second contiguous logic loop may begin at a lower right element of the second canvas. The system may update a first element of the canvas based on an input provided to a second element of the canvas, if the first element receives input from the second element.

The system may allow users to post input information to the elements of the first and second canvases. The input information may include one or more of text data, image data, video data, audio data, audio-visual data, hand-written notes, Uniform Resource Locator (URL) addresses, and data from social media applications. The first and second canvases may include identifiers to distinguish the canvases, and accounts, such as email accounts, that allow the canvases to send and receive information. The first canvas may include a storyboard that receives a text narrative, parses the text, and assigns portions of the text to various elements of the first canvas.

The system may include an encoder that encodes the first and second canvases to indicate the types of assets or resources used to provide the service, how those assets or resources are used to provide the service, and the nature of outcomes that would materialize from the use of the service. The encoded representation of the canvases may be in the form of a color-coded pattern or an alpha-numeric coding. The system may characterize, classify, and/or catalog a design based on the encoded representation.

According to another aspect of one or more exemplary embodiments, there is provided a method for developing a design of a service to be provided to a customer or procured from a service provider. The method according to one or more exemplary embodiments may include generating a first canvas including a plurality of elements that define one or more needs for a service, and a second canvas including a plurality of elements that define a solution that fulfills the one or more needs for the service. The elements of the first canvas may be related by a first contiguous logic loop in which one or more elements in the first canvas are inputs to one or more other elements in the first canvas. The elements of the second canvas may be related by a second contiguous logic loop in which one or more elements in the second canvas are inputs to one or more other elements in the second canvas. The first and second contiguous logic loops may be symmetrical with respect to each other.

The elements of the first canvas and the second canvas may each include 16 elements arranged in a 4×4 array. The first contiguous logic loop may begin at an upper left element of the first canvas, and the second contiguous logic loop may begin at a lower right element of the second canvas. The method may include updating a first element of the canvas based on an input provided to a second element of the canvas, if the first element receives input from the second element.

The method may include receiving input information posted to the elements of the first and second canvases. The input information may include one or more of text data, image data, video data, audio data, audio-visual data, hand-written notes, hand-written drawings or sketches, Uniform Resource Locator (URL) addresses, and data from social media applications. The first and second canvases may include identifiers to distinguish the canvases, and accounts, such as email accounts, that allow the canvases to send and receive information. The first canvas may include a storyboard that receives a text narrative, parses the text, and assigns portions of the text to various elements of the first canvas.

The method may include the step of encoding the first and second canvases to indicate the types of assets or resources used to provide the service, and how those assets or resources are used to provide the service. The encoded representation of the canvases may be in the form of a color-coded pattern or an alpha-numeric coding. The method may include characterizing, classifying, and/or cataloging a design based on the encoded representation.

### BRIEF DESCRIPTION OF THE DRAWINGS

FIG. 1 is a diagram illustrating the relationship between various considerations that define a service to be provided to a customer.

FIG. 2 is a diagram of an unfold canvas according to an exemplary embodiment.

FIG. 2A is a diagram illustrating how information posted to a canvas is processed according to an exemplary embodiment.

FIG. 3 is a diagram of a fold canvas according to an exemplary embodiment.

FIG. 3A is a diagram of an outcome/experience curve of the fold canvas according to an exemplary embodiment.

FIG. 4 is a diagram illustrating the relationship between the unfold canvas of FIG. 2 and the fold canvas of FIG. 3, according to an exemplary embodiment.

FIG. 5 is a diagram illustrating a coding panel of the unfold canvas and fold canvas according to an exemplary embodiment.

FIG. 6 is a diagram showing types of masks that may be used to encode a business model or value propositions of a design according to an exemplary embodiment.

FIG. 7 is an illustration of a masking technique to encode the business model or value propositions associated with a design according to an exemplary embodiment.

FIG. 8 is an illustration of an encoded design according to an exemplary embodiment.

FIG. 9 is a block diagram of a system for implementing the unfold canvas and fold canvas according to an exemplary embodiment.

### DETAILED DESCRIPTION OF EXEMPLARY EMBODIMENTS

Reference will now be made in detail to the following exemplary embodiments, which are illustrated in the accompanying drawings, wherein like reference numerals refer to like elements throughout.

The exemplary embodiments may be embodied in various forms without being limited to the exemplary embodiments set forth herein. Descriptions of well-known parts are omitted for clarity.

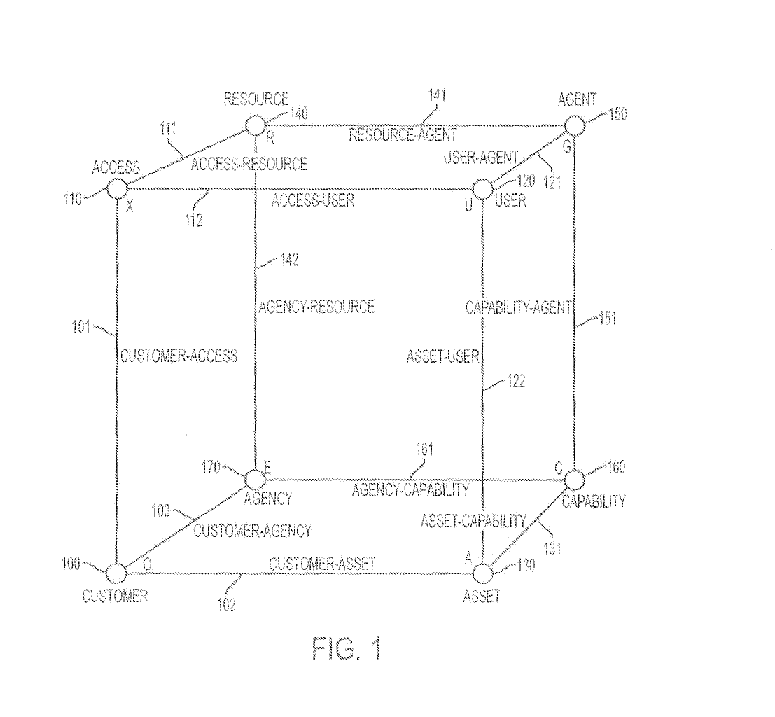

FIG. 1 is a diagram of a cube that illustrates the relationships between various universal elements that define a service that is provided to a customer according to an exemplary embodiment. These universal elements may include eight design perspectives, which are represented as the corners of the cube in FIG. 1. The universal elements may also include twelve design arguments, which are represented as the edges of the cube in FIG. 1. There are two perspectives to each argument, i.e., the two end points of the edge. The design perspectives and design arguments define a service by describing, without limitation, who will use the service, what resources will be used, how will the resources be obtained, etc.

Referring to FIG. 1, customer design perspective 100 defines the customer outcomes (o) that establish the basis for the value received by the customer by using the service. Access design perspective 110 defines the access to resources the customer must rent to make use of and benefit from the service. More specifically, access design perspective 110 may define a particular form, place, and/or time the resource is needed or accessed.

User design perspective 120 defines who will use the customer's assets or access third-party resources as part of providing the service. Users may include persons or personas who are beneficiaries or employees of the customer. The user and customer may also be the same person or entity. Asset design perspective 130 defines asset that the customer owns that the provider of the service will act upon, process, or render to a desired state, to provide the service. For example, in a parcel delivery service, the asset may be the artifact that is being delivered. As another example, in a service that encrypts information for secure transmission, the asset may be the sensitive information to be encrypted.

Resource design perspective 140 defines the external assets the service provider owns and maintains and to which the customer is given access to, but not retain full or permanent ownership, in order to provide the service. For example, in a service that provides DVD rentals at a grocery store, the DVD for rent may be the resource that the customer gets access to on a rental basis, but not for outright ownership by the customer. Skipping ahead, agency design perspective 170 defines the entity or organization with the ability to commit a capability or resource as a service.

Agent design perspective 150 defines persons and personas acting for or on behalf of the agency, who the agency authorizes to engage Users and Assets and facilitate their use of the service. Capability design perspective 160 defines the Agency's capability to render a customer asset to a desired condition or state towards a desired outcome. Agents may embody the Capability or the Resource necessary to deliver the service.

An example of each design perspective is provided below with respect to an exemplary in-flight entertainment service in which an airline contracts with a satellite television (TV) provider to stream live pay-per-view content through satellite. In this example, the customer 100 may be the airline, the agency providing the service 170 may be the satellite TV provider, the asset 130 owned by the customer that is used to provide the service may be the airline's airplane, the access 110 to the resource that is required for the service may be a particular seat on the airplane, and the user 120 that uses the service is the airline passenger. The resource 140 that is rented by the customer may be a live TV event, the agent 150 that is used to facilitate the service is the in-seat console at the passenger's seat, and the capability 160 to render the asset or resource toward the desired outcome of live in-flight content may be the satellite TV provider's high-speed satellite link.

The edges of the cube in FIG. 1 represent design arguments, which are relationships or interactions between the design perspectives. For example, edge 101 may represent the relationship between the customer 100 and the access 110 to resources needed to provide the service at a particular time or place, or in a particular form. Edge 102 may represent the relationship between the customer 100 and the asset 130, and edge 103 may represent the relationship between the customer 100 and the agency 170 that provides the service. For example, edge 103 may represent payment from the customer to the service provider or agency, and the commitment from the service provider or agency to the customer.

Edge 111 may represent the relationship between the required access 110 and the resource 140 utilized to provide the service. For example, in the in-flight entertainment example, edge 111 may identify the need to provide a live TV event (resource) at a particular seat on the airplane (access). Edge 112 may represent the relationship between the 120 user and the access 110 required to use the service. In the in-flight entertainment example, edge 112 may indicate the airline passenger's (user) presence at the seat location (access).

Edge 121 may represent the relationship or interaction between the user 120 and the agent 150 that facilitates the use of the service. Edge 122 may represent the relationship between the user 120 and the asset 130, such as the dependency and control the user 120 may have over the asset 130. Edge 131 may represent the capability 160 of the agency to render the asset 130. In the in-flight entertainment example, edge 131 represents the high-speed satellite link's (capability) connection to the airplane (asset) in order to provide in-flight entertainment.

Edge 141 may represent the relationship between the resource 140 that is utilized and the agent 150 that facilitates use of the service. For example, the in-seat console (agent) uses the live TV event (resource) to provide in-flight entertainment service. Edge 142 may represent the relationship between the resource 140 and the agency 170. Edge 151 may represent how the agent 150 uses the capability 160 to provide the service to the user 120. Edge 161 may represent the relationship between the agency 170 and the capability 160. For example, the satellite TV provider (agency) owns or provides the high-speed satellite link (capability) that is used to provide the service.

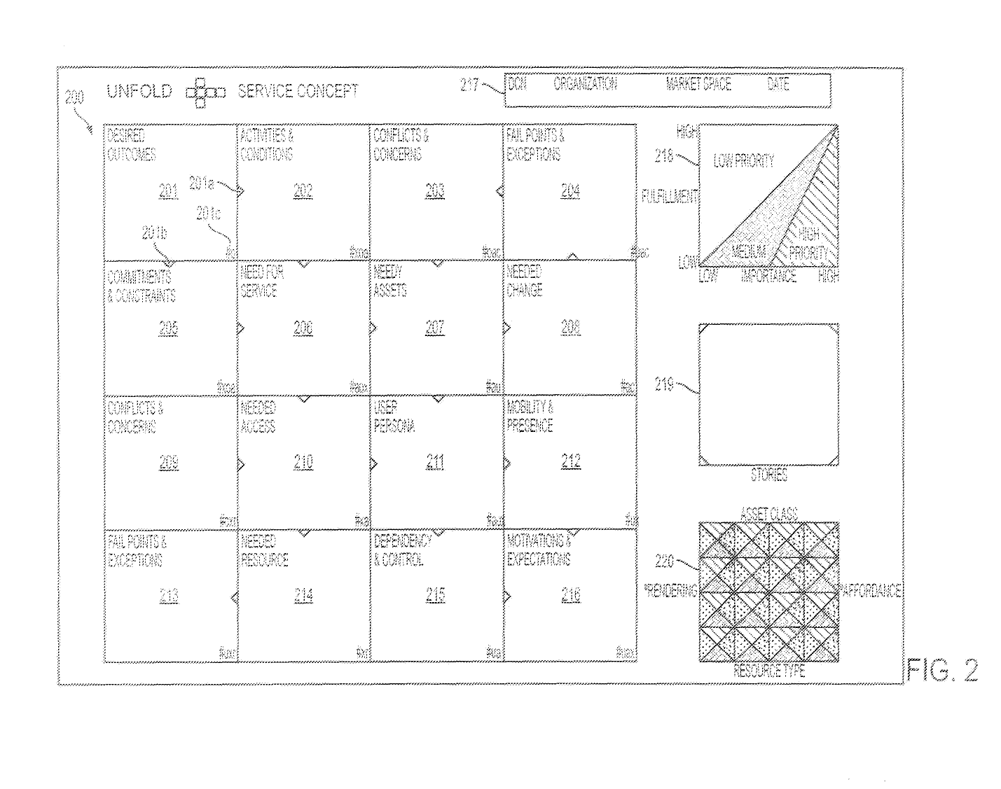

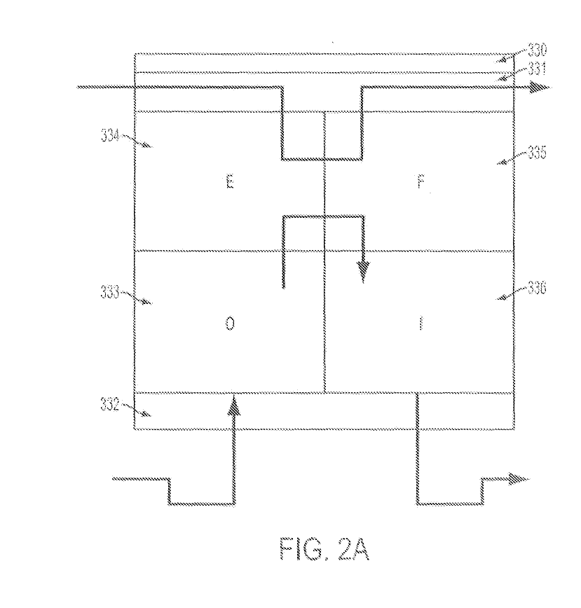

FIG. 2 is a diagram of an unfold canvas for designing and modeling a service according to an exemplary embodiment. The unfold canvas allows a user to identify, define or qualify one or more needs for a service necessitated by the one or more desired customer outcomes. The unfold canvas may be a software object that is dynamically created, populated, edited, updated, tagged, linked, shared, searched, manipulated, locked, stored, displayed, and printed. Referring to FIG. 2, the unfold canvas of the exemplary embodiment includes a 4×4 array 200 of design elements 201-216 that relate to each other via an embedded logic expressed by the design perspectives and design arguments in FIG. 1. Each of the design elements in the 4×4 array 200 may also serve as an album that stores various forms of data relating to a particular aspect of the service. Users may input information relevant to a service by posting the information to a relevant design element. Users may post different types of information to the unfold canvas including, but not limited to: photographs; captions, tags, and comments relating to the photographs; audio and/or video recordings; drawings or sketches created on the canvas or transmitted from an electronic device; digital notes exported from note-taking software; captions, comments, timestamps, Uniform Resource Locators (URLs), and tags associated with images, video, charts, and graphs; text messages; digital chats and “tweets;” charts and graphs from data visualization tools.

The elements of the unfold canvas may be interactive, responding to touch on a touch-screen enabled device, mouse clicks, or other user interfaces. The canvas may allow the user to perform the following exemplary actions to each element: zoom-in; zoom-out; open; close; and turn or flip to reveal or hide underlying content. Each element may also include checklists and forms to ensure sufficient information has been provided to the element in an organized format. The unfold canvas and the elements may issue instructions, alerts, requests, or other messages to other entities, such as other canvases or elements. For example, if new information is input to first element, that element may send an alert to a second element that receives input from the first element to notify the second element that the second element may have a new input to process. The alert may be in the form of text, audio, video, and/or images. The elements may correspond to folders in a networked folder structure. For example, each element may be a folder in file sharing service such as Dropbox or Evernote.

Referring to FIG. 2, element 201 may be a Desired Outcomes element that defines the customer outcomes that establish the basis for customer value from using the service. Element 201 may correspond to the customer design perspective 100 in FIG. 1. Element 201 outputs data to elements 202 and 205, as indicated by notches 201a and 201b, respectively. The remaining elements in the unfold canvas also include notches to indicate the flow of information between elements. Element 201 may also include an identifier 201c that allows users to post information to element 201 by referencing identifier 201c. For example, identifier 201c may be a hash tag that the user can reference when posting a photograph to element 201. The remaining elements in the unfold canvas may also include identifiers that allow users to post information to specific elements. In addition, elements in the unfold canvas may post information to other elements in the unfold canvas. For example, an element that outputs data to another element may transmit data that it receives to the other element by referencing the other element's identifier. Identifier 201c and the identifiers of the other elements may be used for filtering, searching, sorting and routing design content from users and databases. The identifiers may begin with a ‘#’ symbol followed by a string of one or more of the letters representing the eight design perspectives in FIG. 1 (i.e., O, A, U, X, R, G, C, E).

Element 202 may be an Activities & Conditions element that defines key activities, conditions, and tasks that realize outcomes and establish the need for a service. Element 202 may correspond to edges 101 and 102 in FIG. 1, and clarifies one or more commitments and constraints that impede, inhibit or limit the activities, conditions and tasks, jeopardize outcomes and therefore create the need for a service. Element 202 receives input from element 201 and outputs data to element 206.

Element 205 may be a Commitments & Constraints element that identifies the commitments and constraints that impede, inhibit or limit one or more of the Activities & Conditions, jeopardize outcomes, and therefore create the need for a service. Element 205 may correspond to edges 101 and 102 in FIG. 1, and clarify the activities, conditions, and tasks that realize outcomes and establish the need. Element 205 receives input from element 201 and outputs data to element 206.

Element 206 may be a Need For Service element that further explores, clarifies, and establishes the need for a service. Element 206 may correspond to edges 101 and 102 in FIG. 1. Element 206 receives input from elements 202 and 205, and outputs data to elements 207 and 210.

Element 207 may be a Needy Assets element that elaborates and explains the need for a service in terms of customer assets. Element 207 may correspond to edge 122 in FIG. 1. Element 207 receives input from elements 206 and 203, and outputs data to elements 208 and 211.

Element 208 may be a Needed Change element elaborates and explains the rendered state in which the Needy Assets will be more useful and valuable. Element 208 may correspond to edge 131 in FIG. 1. Element 208 receives input from element 207 and outputs data to element 204.

Element 204 may be a Fail Points & Exceptions element that describes faults, errors, failures and exceptions that prevent, prohibit or inhibit the needed change. Element 204 may correspond to edges 122 and 131 in FIG. 1. Element 204 receives input from element 208 and outputs data to element 203.

Element 203 may be a Conflicts & Concerns element that identifies conflicts and concerns associated with both the needed change and failures and exceptions to having the needed change. Element 203 may correspond to edges 102 and 131 in FIG. 1. Element 203 receives input from element 204 and outputs data to element 207. Elements 207, 208, 204, and 203 form a feedback logic loop in which the content of element 207 is reviewed and validated in one or more iterations through elements 208, 204, and 203.

Element 209 may be a Conflicts & Concerns element that identifies conflicts and concerns associated with both the needed access, and failures and exceptions to having the needed access. Element 209 may correspond to edges 101 and 111 in FIG. 1. Element 209 receives input from element 213 and outputs data to element 210.

Element 210 may be a Needed Access element that elaborates and explains the need for a service in terms of needed access to resources the customer needs but does not have. Element 210 may correspond to edges 112 in FIG. 1. Element 210 receives input from elements 206 and 209, and outputs data to elements 211 and 214.

Element 214 may be a Needed Resource element that defines the resource to be made readily available for use, whenever and wherever access to the resource is needed, as per the elaboration and explanation in Element 210. Element 214 may correspond to edge 111 in FIG. 1. Element 214 receives input from element 210 and outputs data to element 213.

Element 213 may be a Fail Points & Exceptions element that describes faults, errors, failures and exceptions that prevent, prohibit, or inhibit access to the needed resource. Element 213 may correspond to edges 111 and 112 in FIG. 1. Element 213 receives input from element 214 and outputs data to element 209. Elements 210, 214, 213, and 209 form a feedback logic loop in which the content of element 210 is reviewed and validated in one or more iterations through elements 214, 213, and 209.

Element 211 may be a User Persona element that defines the persons and personas who will use the service, receive the benefits, and define or validate the outcomes and experiences associated with the service. Element 211 may correspond to edges 112 and 122 in FIG. 1. Element 211 receives input from elements 207 and 210, and outputs data to elements 212 and 215.

Element 212 may be a Mobility & Presence element that describes the mobility and presence of users to determine when, where, why, and how the users will present the need for access to the resources of the service. Element 212 may correspond to edge 112 in FIG. 1. Element 212 receives input from element 211 and outputs data to element 216.

Element 215 may be a Dependency & Control element that defines and highlights the dependency and control users have over needy assets with respect to the need for the service. Element 215 may correspond to edge 122 in FIG. 1. Element 215 receives input from element 211 and outputs data to element 216.

Element 216 may be a Motivations & Expectations element that analyzes the deeper motivations and expectations of user personas that shape and influence the desired user experience. Element 216 may correspond to edges 112 and 122 in FIG. 1. Element 216 receives input from elements 215 and 212.

The unfold canvas may also include a canvas header 217 that provides contextual information relating to the unfold canvas. For example, header 217 may include a design or document control number (DCN) that allows the unfold canvas to be uniquely identified. Header 217 may also include organization information, market space, and date information indicating the organization for which the canvas is created, the market space within which the service fulfills a need, and the date the canvas was first created or last updated. These fields are merely exemplary, and header 217 may include additional or other identifying information. For example, the unfold canvas may include an email account or other type of account through which information may be transmitted and received. According to an exemplary embodiment, the unfold canvas may exchange information with other canvases using each canvas' email address.

The unfold canvas may also include an opportunity map 218 that evaluates the need for the service and provides a visual reference for users to focus on designing the service for the most critical needs. According to an exemplary embodiment, opportunity map 218 may indicate the importance of the need for the service along the horizontal axis and indicate the degree to which the need has been fulfilled on the vertical axis. For each Need for Service identified in element 206, an opportunity score is calculated and plotted on the opportunity map 218. According to an exemplary embodiment, the opportunity score may be calculated based on the underlying activities and conditions identified in element 202 and the commitments and constraints identified in element 205. The activities and conditions from element 202 may be used to derive the importance of the need for service, and the commitments and constraints from element 205 may be used to derive the extent to which the need has been fulfilled. Information from other design elements in the unfold canvas may also be used to determine the importance of a need for a service, and the extent to which the need has been fulfilled. The opportunity map 218 may be divided into multiple priority levels that indicate the relative priority of each need for service. For example, a need for service that exhibits a high degree of importance and low degree of fulfillment may be a high priority need for service. On the other hand, a need for service having a low degree of importance and a high degree of fulfillment may be a low priority need for service.

The unfold canvas may also include a storyboard 219 that captures narratives relevant to the service concept from the perspective of customers and users. Each narrative provides ideas, observations, and insight about how the service can be valuable to customers in terms of outcomes, and to users in terms of experience. Users may import text files or cut and paste existing text into the storyboard 219. Users may also email narratives to the canvas by referencing an identifier associated with the storyboard 219.

According to an exemplary embodiment, the storyboard 219 may parse the text of the narrative and assign the appropriate design perspectives and arguments described in FIG. 1 to each portion of the narrative. A portion of the narrative may be assigned multiple perspectives and/or arguments. The user may assign the design perspectives and arguments, or the canvas can suggest appropriate design perspectives and arguments for the users review. The unfold canvas may suggest design perspectives and arguments based on previous allocations of subject matter to particular elements. For example, the canvas may identify terms or phrases from previous narratives that have been assigned certain design perspectives and arguments, and allocated to particular design elements. Once the design perspectives and arguments have been assigned, the parsed portions of the narrative are posted to corresponding elements in the 4×4 array 200. Portions of the narrative may be assigned to elements of the unfold canvas by matching the design perspectives and arguments assigned to narrative portion with the identifier 201c of the design element.

The unfold canvas may also include a coding panel 220 that graphically expresses the embedded value propositions or design intent associated with the service. The coding panel may include a 4×4 array of cells that defines value propositions based on information posted to design elements 201-216. For example, the four vertical columns may correspond to four classes of noun objects (assets and resources), and the four horizontal rows may correspond to four classes verb objects (treatment of the assets and resources). Each cell in the coding panel 220 defines a market space that matches a class of noun objects with a class of verb objects. Each cell indicates the extent to which the noun-verb pair creates value by rendering a customer-owned asset or by providing resources “on-rent” at particular places, times, and formats. Each cell also indicates whether the value proposition relates to avoiding losses for the customer or affecting gains for the customer. A more detailed description of the coding panel 220 is provided below.

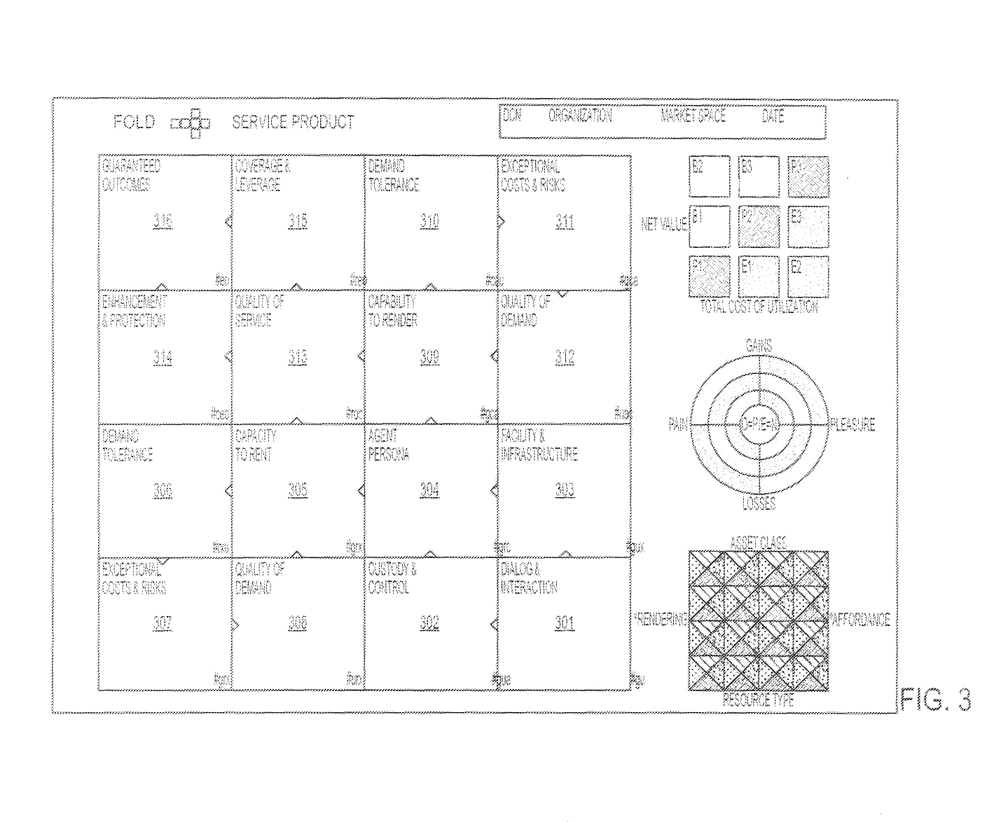

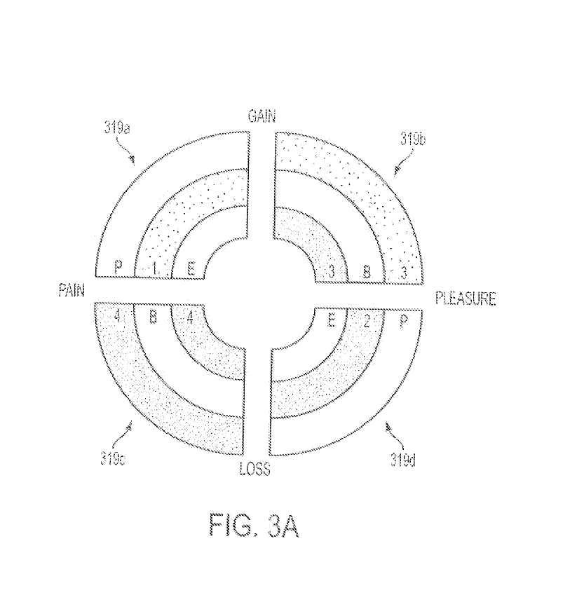

FIG. 2A is a diagram illustrating how information is processed once it is posted to the design elements of the unfold canvas according to an exemplary embodiment. FIG. 2A and the corresponding description provided below also applies to processing of information by design elements of the fold panel described below with reference to FIG. 3.

Referring to FIG. 2A, content that is posted to a design element in the unfold canvas or fold canvas is stored in the form of an idea, which includes three sections according to an exemplary embodiment: a header section, a detail section, and a metadata section. The header section may include a header identifier 330 and a header statement 331. The detail section may include an expression field 334 and a form field 335. The metadata section may include a reference field 332, an observation field 333, and an insight field 336.

The header section contains information for identifying an idea within a collection of ideas, and for stating and displaying the caption or title of the idea, which usually also serves as the subject line or short statement of the Idea. Headers may be useful for searching, sorting, cataloging and listing ideas. For example, the header identifier may be local to the canvas containing the idea, and may include a serial number and an address. The serial number may be generated by the system based on the timing or sequence of creating the idea. The address may be based on the position of the idea within the unfold or fold canvas, i.e., which design element in the canvas contains the idea. Creating a new idea may prompt the automatic generation of a new identifier. Copying an idea from one design element to another design element may result in a new identifier for the copy based on the timing and placement of the copy. The identifier of the copy may also indicate the relationship to the original idea. The address of the idea may change if the idea is moved from one design element to another. The metadata section of the idea may record the address history to track the idea over time.

The header statement 331 may include a caption or title for an idea that describes the subject matter of content of the idea. For example, if the user posts a video file to a design element in the unfold canvas of FIG. 2, the system may prompt the user to enter a brief description of the video, which will be stored in the header statement 331.

The detail section of the idea may expound and furnish details of the idea in a rich and complete manner, expressed using a variety of formats and a set of pre-defined forms. The detail section may represent the main body of an idea, and may be edited, updated and enriched using observations from observation field 333. The detail section may also generate insights in insight field 336, which is the output of the idea.

The expression field 334 of the detail section may capture the idea in any possible form from any possible source without regard for form or structure. The expression field 334 provides a fast and simple way for a participant in a design exercise to expound on and explain an idea by permitting the participant to present relevant examples and evidence. For example, a user can quickly write a note, draw a picture or attach a file that contains a picture or a video that embodies the idea that is to become part of the design. Expressing the idea may include the acts of capturing, encapsulating and detailing the idea in a convenient and suitable format, such as, without limitation, text, image, audio, video, document, artifact, and URL. Also, individuals and organizations may post information to the expression field 334 by using electronic and social media platforms to search, capture, tag, download, organize, distribute and share content, using a plurality of devices and platforms, including mobile phones, web browsers and tablet computers. Text format may be used for expressing the idea using notes, messages, memos, etc. Image format may be used for diagrams, drawings, photos, snapshots, etc. Audio and video format may be used for the analog and digital recordings of speech, sound, animation, television, film, motion, etc. The document format may be used for expressing the idea by making use of documents created in popular formats for viewing documents such as Word, PDF, Excel, PowerPoint, etc. The expression field 334 of the detail section does not impose any structure or form for input, to allow for spontaneity and speed in the providing of input. Accepting input in a plurality of formats and states of finish, from anyone, anytime, and anywhere, accelerates the design effort and enriches it with knowledge and insight that's otherwise simply unexploited in most organizations. It also facilitates the engaging of stakeholders across an organization on different terms or mode of engagement, by letting them contribute whatever they can through documents, memos, notes, pictures, drawings, charts, voice memos and video clips. This social and inclusive method of gathering information and design means engaging stakeholders who would otherwise be left out, and those who have very little time to participate in a more formal way.

While the expression field 334 is for allowing the spontaneity and speed necessary to facilitate creative and collaborative efforts, the form field 335 is for ensuring due diligence, quality and integrity in the detailing of an idea and the overall development of the design. The form field 335 may be used to codify the idea into a design based on the logic and definition of the particular design element in which the idea is embedded or placed. The codification allows for systematic analysis and structured definition of the overall design. When the design effort is completed, the information captured in the form makes it easier to distribute work and issue work orders or instructions for the planning and implementing of design. Also, the forms may implement a checklist-based system for ensuring the ideas are not missing any important detail.

Users or the system may fill the forms based on information in the header statement 331 and the expression field 334. The form field 335 may provide a set of questions to answer, or checklists and data fields to which users may provide input. For example, if the expression field 334 contains a video describing a widely observed fail point, users may describe, characterize and generalize the fail point simply by filling out the form, which may be in a checklist format. Going through the checklist and completing the form while watching and annotating the video, codifies the idea around possible fail points, into a design. Each design element of the canvas may have at least one particular form unique to that design element to capture and codify ideas placed in the design element. Design elements may also have more than one form for each instance of an idea placed within its confines or context.

Referring to the metadata section, the observation field 333 may receive input relating to the idea from a user or the system in the form of advice, comments, explanations, instructions, notes, recommendations, and summaries. Users or the system may actively place the input directly into the observation field 333; or the input may be read from (pulled from or requested) from the insight field 336 of one or more other ideas; or the input may be written to the observation field 333 (pushed from or sent) by the insight field 336 of one or more other ideas. Observations may further detail, expand, and substantiate the expression contained in the expression field 334 by providing as input, among other things, facts and assertions, including empirical evidence and quantitative information. The information in the observation field 333 may be in any of the formats used to fill the expression field 334.

The insight field 336 of the metadata section may be used for sending output of an idea to be received by a user or the system as input for another idea. Users or the system generate insight gained from the idea, or describe the insight to be gained from the idea, by entering advice, comments, explanations, instructions, notes, recommendations and/or summaries into the insight field 336. The information in the insight field 336 may be in any of the formats used to fill the observation field 333. Using the information in the form field 335 as guidance ensures that the insight field 336 includes the clarity and completeness or coverage necessary for the information to be useful as input to users or the system in the context of ideas elsewhere in the canvas or other canvases. Filling the insight field 336 with information may require that the expression field 334 and form field 335 contain adequate information.

When the information in the expression field 334 and form field 335 is missing, the users or the system may be prompted to generate it directly within the idea, pull it from the observation field 333; or pull it from or request it from ideas in other canvas components elsewhere, following the logical connections defined between the 4×4 array of functions and other canvas components such as the Storyboard, encoding panels, and O/E curves, which are described in more detail below.

The reference field 332 of the metadata section may store information for characterizing, classifying, associating, and indexing an idea, among a plurality of ideas, with links, addresses, identifiers, tags and other forms of references. The information contained in this field provides context to the information contained in the rest of idea; tracks the placement and movement of the idea among a plurality of ideas within and across canvases; and enables a registry of relationships between ideas defined by the design logic in contiguous loops.

When an idea is created or placed in a design element of a canvas, a default tag may be placed in the reference field 332 based on the identifier or hash tag of the design element, prompting the idea to inherit the properties, methods and behaviors of the hosting design element. This is consistent and conformant to the principles of object-oriented architecture and programming in software development. For example, when an idea is created or placed in the Desired Outcome design element 201 of the unfold canvas, the system may generate a default tag #O in the reference field 332.

In addition to the default tag, users may place additional tags in the reference field 332, indicating or signaling to other users and the system components the presence of additional context, association and meaning. For example, in addition to the tag #O, the tags #teleconference and #remoteaccess may be used, for example, in a design for a service providing remote computer access. The additional tags may be words, phrases, acronyms, mnemonics or any other combination of alphanumeric characters that are easily recognized for the additional context and meaning they provide. Such tags allow users and system components to generate fast associations, questions and observations related to the design and innovation processes.

The tags may be useful in the indexing, searching, sorting, listing and tabulation of ideas, their relationships, and instances. For example, users or system components may search, sort and group all ideas with a particular tag, to understand and analyze a particular design challenge or subject matter.

The reference field 332 may also be used for creating, maintaining and updating relationships between ideas, such as, without limitation, parent-child, original-copy, and base-derivative. These relationships between ideas are formed when ideas are copied, moved, split, joined, merged and grouped. For example, when an idea in the User Persona design element 211 is elaborated in the Dependency & Control 215 and Mobility & Presence 212 design elements of the unfold canvas, two new ideas may be created, one each in the two receiving functions. The new ideas may inherit the default tags of their hosting design elements, and also an inherited reference to the parent idea in the User Persona element 211. The inherited reference may be a copy of the identifier field in the header section 330 of the parent idea; or a derivative of the same. Similarly, when two ideas are combined to form a new idea as part of a conclusion, the new idea may inherit parent references from the said two ideas.

FIG. 3 is a diagram of a fold canvas for designing and modeling a service product that will deliver the outcomes desired by the customer, according to an exemplary embodiment. The design of the fold canvas is largely from the perspective of the agency or service provider. The fold canvas may systematically define the capabilities and resources required to fulfill the need for a service, define the quality of demand necessary to deliver a particular quality of service, while accounting for exceptional costs and risks, and to deliver the user experience calibrated by desired customer outcomes defined in the unfold canvas. Referring to FIG. 3, the fold canvas of the exemplary embodiment includes a 4×4 array 300 of design elements 301-316 that relate to each other via an embedded logic expressed by the design perspectives and design arguments illustrated in FIG. 1. Like the unfold canvas of FIG. 2, each of the design elements in the 4×4 array 300 also serves as an album that stores data in various forms relating to a particular aspect of the service product. The same functionality and user interaction described above in connection with the unfold canvas of FIG. 2 also apply to the fold canvas shown in the exemplary embodiment of FIG. 3. For example, elements 301-316 may include notches 301a and 301b that indicate the flow of information between elements. Each element may also include an identifier 301c that can be used to filter, search, sort, and route design content from users and databases. The identifiers may be in the format of a ‘#’ symbol followed by a string of one or more of the letters representing the eight design perspectives in FIG. 1 (i.e., O, A, U, X, R, G, C, E).

Referring to FIG. 3, element 301 may be a Dialogue & Interaction element that defines the dialogue and interaction necessary between users and service agents. Element 301 may correspond to edge 121 in FIG. 1. Element 301 receives input from the Motivations & Expectations element 216 from the unfold canvas, and outputs data to elements 302 and 303.

Element 302 may be a Custody & Control element that defines the ways and means for agent personas to gain custody and control of needy assets from user personas who depend on or control the needy assets. Element 302 may correspond to edges 121 and 122 in FIG. 1. Element 302 receives input from element 301 and outputs data to element 304.

Element 303 may be a Facility & Infrastructure element that defines the facility and infrastructure that define or enable access to the service and the underlying resources, and make the service convenient and compelling from the user perspective. Element 303 may correspond to edges 112 and 121 in FIG. 1. Element 303 receives input from element 301 and outputs data to element 304.

Element 304 may be an Agent Persona element that defines the persons and personas with the capabilities, resources, authority, and responsibility to coordinate and control the delivery of the service. Element 304 may correspond to edges 141 and 151 in FIG. 1. Element 304 receives input from elements 302 and 303, and outputs data to elements 305 and 309.

Element 305 may be a Capacity to Rent element that defines the resources and capabilities required to provide customers the needed access to particular resources with a high degree of confidence and control. Element 305 may correspond to edges 141 and 142 in FIG. 1. Element 305 receives input from elements 304 and 308, and provides output to elements 306 and 313.

Element 306 may be a Demand Tolerance element that defines the tolerance for errors, exceptions and variations in the quality of demand generated by user personas and their needed access to needed resources. Element 306 may correspond to edges 111 and 112 in FIG. 1. Element 306 receives input from element 305 and outputs data to element 307.

Element 307 may be an Exceptional Costs & Risks element that identifies the exceptional costs and risks from tolerating errors, exceptions, and variations in the quality of demand generated by the access needed to provide the service. Element 307 may correspond to edges 111 and 141 in FIG. 1. Element 307 receives input from element 306 and outputs data to element 308.

Element 308 may be a Quality of Demand element that defines the quality of demand expected from customers to enable, underwrite or justify superior access to needed resources at a lower total cost of utilization. Element 308 may correspond to edges 111 and 142 in FIG. 1. Element 308 receives input element 307 and outputs data to element 305. Elements 305, 306, 307, and 308 form a feedback logic loop in which the content of element 305 is reviewed and validated in one or more iterations through elements 306, 307, and 308.

Element 309 may be a Capability to Render element that defines the capabilities and resources needed to render customer assets with needed change with a high degree of confidence and control. Element 309 may correspond to edges 151 and 131 in FIG. 1. Element 309 receives input from elements 304 and 312, and outputs data to elements 310 and 313.

Element 310 may be a Demand Tolerance element that defines the tolerance for errors, exceptions, and variations in the quality of demand generated by needy assets and user personas. Element 310 may correspond to edges 122 and 131 in FIG. 1. Element 310 receives input from element 309 and outputs data to element 311.

Element 311 may be an Exceptional Costs & Risks element that identifies the exceptional costs and risks from tolerating errors, exceptions and variations in the quality of demand generated by needy assets and user personas. Element 311 may correspond to edges 151 and 131 in FIG. 1. Element 311 receives input from element 310 and outputs data to element 312.

Element 312 may be a Quality of Demand element that defines the quality of demand expected from customers to enable, underwrite or justify the superior rendering of customer assets at a lower total cost of utilization. Element 312 may correspond to edges 122 and 131 in FIG. 1. Element 312 receives input from element 311 and outputs data to element 309. Elements 309, 310, 311, and 312 form a feedback logic loop in which the content of element 309 is reviewed and validated in one or more iterations through elements 310, 311, and 312.

Element 313 may be a Quality of Service element that defines the quality of service delivered in terms of rendering customer assets and/or provisioning of needed access to resources on rent. Element 313 may correspond to edges 142 and 161 in FIG. 1. Element 313 receives input from elements 305 and 309, and outputs data to elements 314 and 315.

Element 314 may be an Enhancement & Protection element that defines how the rendering of customer assets by the service correlates with, causes or results in gains accumulated and/or the losses avoided by the customer. Element 314 may correspond to edges 103 and 161 in FIG. 1. Element 314 receives input from element 313 and outputs data to element 316.

Element 315 may be a Coverage & Leverage element that defines how the provisioning of needed access to needed resources on rent by the service correlates with, causes or results in gains accumulated and/or the losses avoided by the customer. Element 315 may correspond to edges 103 and 142 in FIG. 1. Element 315 receives input from element 313 and outputs data to element 316.

Element 316 may be a Guaranteed Outcomes element that defines the customer outcomes assured from the use of the service. Element 316 may correspond to edge 103 in FIG. 1. Element 316 receives input from elements 314 and 315.

The fold canvas may include a canvas header 317 that provides additional information relating to the fold canvas. Like header 217 in the unfold canvas, header 317 in the fold canvas may include organization information, market space, and date information indicating the organization for which the canvas is created, the market space the service operates within, and the date the canvas was created. These fields are merely exemplary, and header 317 may include additional or other identifying information.

The fold canvas may also include a crop chart 318 used to define and structure the service offering into options and bundles that best fulfill the customer needs across various user segments, through a guaranteed set of outcomes and experiences. Each bundle seeks to maximize the net value for the customer while minimizing the total cost of utilization. The crop chart may include three types of features and functions or aspects of the service, bundled and offered as service packages: basic factors, performance factors, and excitement factors. Basic factors B1, B2, and B3 may represent must-have aspects of the service or “hygiene factors” that customers take for granted, and which cause customer dissatisfaction to rise dramatically when these factors are missing or inadequate. After a certain level of fulfillment there are diminishing returns because customers are not willing to pay more for further provisions of basic factors. Performance factors P1, P2, and P3 may represent should-have aspects of the service that customers would like to have in various extents or levels, and which cause customer satisfaction to increase or decrease in linear proportion to the level being offered. Excitement factors E1, E2, and E3 may represent nice-to-have aspects of the service that customers do not expect but are very happy to receive. Customer satisfaction increases dramatically when these factors are present even to a limited extent.

Using crop chart 318, different combinations of the service factors can be bundled to provide various levels of service to the customer. The vertical axis of crop chart 318 may indicate net value that accrues to the customer from utilizing the service, and the horizontal axis of the crop chart 318 may indicate the associated total cost of utilization. As shown in FIG. 3, performance factors P1, P2, and P3 indicate components of a service that provide a net value to the in more or less linear proportion to the total cost of utilization. Basic factors B1, B2, and B3 form a curve indicating that there are diminishing returns in terms of the net value provided by these factors with an increase in the total cost of utilization. On the other hand, excitement factors E1, E2, and E3 form a curve indicating that associated factors would contribute to a dramatic increase in the net value of the service at a relatively low increase in the total cost of utilization. As ideas are posted to the fold canvas, the ideas are categorized into B, P, and E factors, as will be described below. Once an idea is classified as a B, P, or E factor, the user or the system may determine whether the idea the number (i.e., 1, 2, or 3) associated with the factor depending on the relative value and cost associated with the idea.

The fold canvas may also include an Outcome/Experience curve (O/E curve) 319 that illustrates the tensions and trade-offs between the quality of outcomes and the quality of experience to facilitate decisions that maximize the net value to the customer. Outcomes are evaluated in terms of gains and avoided losses from using the service. Experience is evaluated in terms of pleasure-to-pain ratio based on how customers or users feel about the service, with respect to enrollment, engagement, entrustment and enforcement. How desired outcomes are priced, packaged, and delivered has an impact on the quality of outcomes and the net value of the service. Based on whether the quality of outcomes increases or decreases with an increase in the quality of experience, there may be four sets of O/E curves. The top-left quadrant of the O/E curve 319 illustrates the situation in which an increase in the quality of experience leads to an increase in affected gains. The top-right quadrant of the O/E curve 319 illustrates the situation in which an increase in the quality of the experience leads to a decrease in affected gains. The bottom-right quadrant of the O/E curve 319 illustrates the situation in which an increase in the quality of the experience leads to an increase in avoided losses. The bottom-left quadrant of the O/E curve 319 illustrates the situation in which an increase in the quality of the experience leads to a decrease in avoided losses. Ideas from the fold canvas are classified as B, P, or E factors using the O/E curve, as discussed in further detail below with reference to FIG. 3A.

The fold canvas may also include a coding panel 320 that is essentially the same as the coding panel 220 in the unfold canvas, with the exception that the coding panel 320 expresses value propositions based on information posted to design elements 301-316. A more detailed description of coding panels 220 and 320 is provided below.

FIG. 3A is a diagram of the O/E curve 319 in FIG. 3 according to an exemplary embodiment. In the exemplary embodiment, ideas from the fold canvas are plotted on the O/E curve based on the relationship between customer's experience (i.e., pain vs. pleasure) and the benefit obtained by the customer (gain vs. avoiding loss). For example, the user or system may identify ideas from the fold canvas that increase the quality of the experience and increase the affected gains. If this relationship is linear, or sensitivity is low, the idea is plotted on the P curve among the family of PIE curves 319a. Following the P curve clockwise, as the gain increases, the experience (i.e., pleasure) increases. If the relationship is non-linear, or sensitivity is high, the idea is plotted on the E curve in the PIE curve family 319a. If the idea expresses a limitation on the relationship, such as an external factor that limits the practical ability to affect gain, the idea is plotted on the 1 curve in the PIE family of curves 319a. Once an idea has been plotted as on the P or E curve in the PIE family of curves 319a, the idea may then be assigned to a corresponding P or E factor in the crop chart 318 of FIG. 3. For example, if the idea is plotted on the P curve, the user or the system may assign the idea to the P1, P2, or P3 factors in the crop chart 318 based on the relative value and cost associated with the idea. If the idea is plotted on the E curve in the PIE family of curves 319a, the idea is assigned to the appropriate E factor in the crop chart 318.

With further reference to FIG. 3A, the 3B3 family of curves 319b indicates ideas in which an increase in the quality of experience leads to a decrease in affected gains. Ideas that meet these criteria are plotted on the B curve in the 3B3 family of curves 319b. If the relationship between experience and outcome is generally linear, the idea is plotted on outer curve 3 of the family of curves 319b. If the relationship between the experience and outcome is non-linear, the idea is plotted on the inner curve 3 of the family of curves 319b. Once the idea is plotted on the appropriate curve, the idea may be mapped to the crop chart 318 as a B factor.

The 4B4 family of curves 319c indicates ideas in which an increase in the quality of the experience leads to a decrease in avoided loss. Ideas that meet these criteria may be plotted on the B curve in the 4B4 family of curves 319c. If the outcome/experience relationship is generally linear, the idea is plotted on the outer 4 curve of the 4B4 family of curves 319c, and if the outcome/experience relationship is non-linear, the idea is plotted on the inner 4 curve of the 4B4 family of curves 319c. The plotted idea may then be transferred to an appropriate B factor on the crop chart 318.

The P2E family of curves 319d indicates ideas in which an increase in the quality of the experience leads to an increase in avoided loss. If the outcome/experience relationship is generally linear, the idea is plotted on the lower P curve of the P2E family of curves 319d. If the outcome/experience relationship is non-linear, the idea is plotted on the lower E curve of the P2E family of curves 319d. If the idea expresses a limitation on the relationship, such as an external factor that limits the practical ability to avoid loss, the idea is plotted on the 2 curve in the P2E family of curves 319d. The idea can then be assigned to the appropriate P or E factor in the crop chart 318.

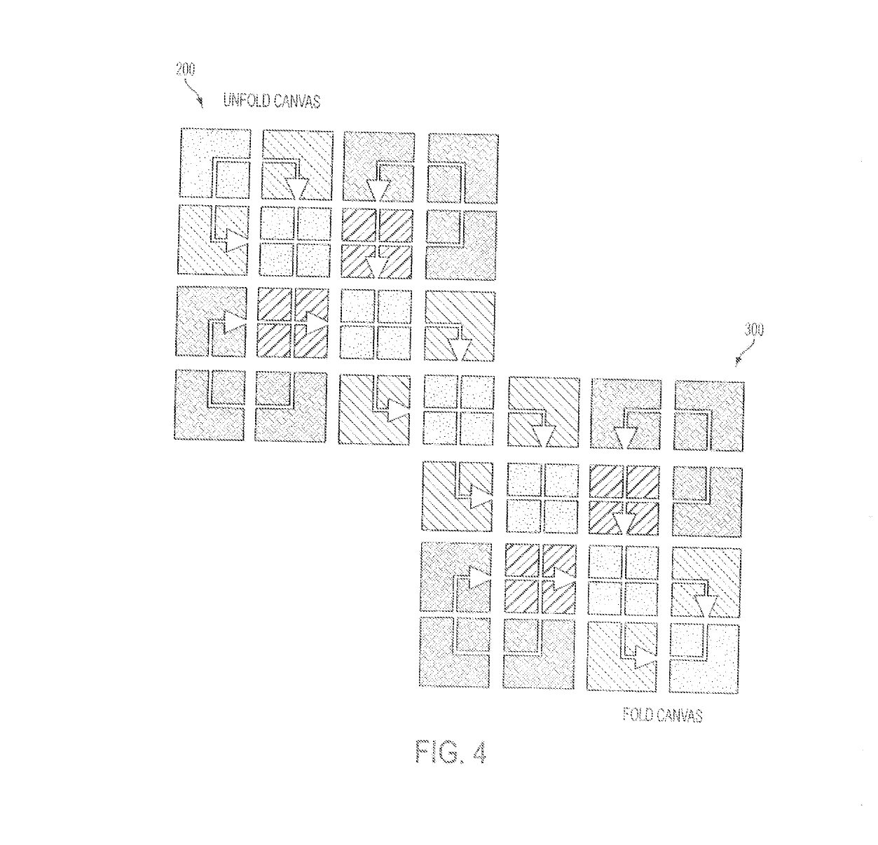

FIG. 4 is a diagram illustrating the relationship between the unfold canvas and the fold canvas according to an exemplary embodiment. The unfold canvas and the fold canvas combine to form a complete design blueprint. Referring to FIG. 4, the unfold canvas and the fold canvas are symmetrical with respect to teach other. The Motivations and Expectations element 216 of the unfold canvas outputs data to the Dialog & Interaction element 301 of the fold canvas. In addition, the two canvases can be used to perform an integrity check for the design of the service. For example, the Guaranteed Outcomes element 316 of the fold element may be compared with the Desired Outcomes element 201 of the unfold canvas in order to verify that the outcomes provided by the service meet or exceed the desired outcomes of the customer.

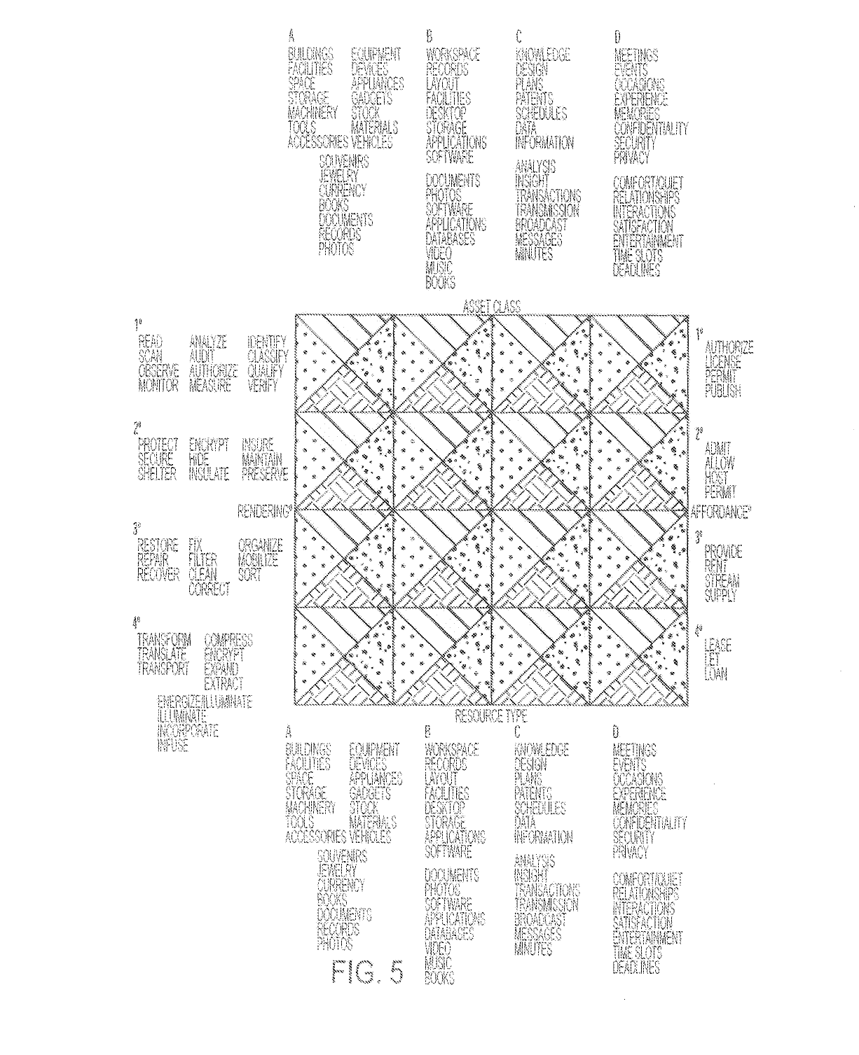

FIG. 5 is a diagram illustrating the operation of coding panels 220 and 320 of FIG. 2 and FIG. 3. Referring to FIG. 5, the coding panel of the exemplary embodiment includes four vertical columns, each of which is associated with a group of nouns that reflect assets owned by the customer and resources provided by the agency with respect to the provision and use of a service. The coding panel of FIG. 5 also includes four horizontal rows that correspond to four groups of verbs describing how the assets and resources of the vertical columns may be rendered or utilized to provide the service. The verbs on the left side of the coding panel may include verbs relating to rendering assets that are owned by the customer, and the right side of the coding panel may include verbs relating to the provisioning and renting of resources that are not owned by the customer. The nouns and verbs of the coding panel may be revised or selected by the user in the form of a controlled vocabulary that is specific and relevant to a particular market or service domain, such as healthcare, financial services or information technology. Alternatively, the nouns and verbs may be populated based on ideas posted to design elements in the unfold canvas or fold canvas. For example, coding panel 220 in the unfold canvas, may derive nouns and verbs from ideas posted to design elements 201-216 in the unfold canvas. Coding panel 320 in the fold canvas may derive nouns and verbs from ideas posted to design elements 301-316 in the fold canvas.

The coding panel includes 16 cells that describe market places according to the various classes and combinations of nouns and verbs. According to the exemplary embodiment, each cell is in the shape of a square that is divided into four quadrants that each indicate the presence or relevance of a value proposition, and indicate the extent to which the value proposition is based on rendering a customer-owned asset versus renting a resource that is not owned by the customer, and whether the value proposition relates to affecting gain or avoiding loss. According to the exemplary embodiment, the top quadrant corresponds to an asset that is owned by the customer, while the bottom quadrant corresponds to a resource that is provided ‘on-rent’ to the customer. According to the exemplary embodiment, the right quadrant corresponds to gain that is affected by using the service, and the left quadrant corresponds to loss that is avoided by using the service. For example, rendering of customer-owned asset to affect a gain would be represented by the top and right quadrants of the cell. In addition, a particular combination of nouns and verbs may include multiple value propositions. For example, provision of a resource not owned by the customer may both affect gain and avoid loss, in which case the left, right, and bottom quadrants would apply. At a given moment in time, each cell may reflect the presence or relevance (in terms of need) of zero, one, two, three, or all four of the four types of value propositions.

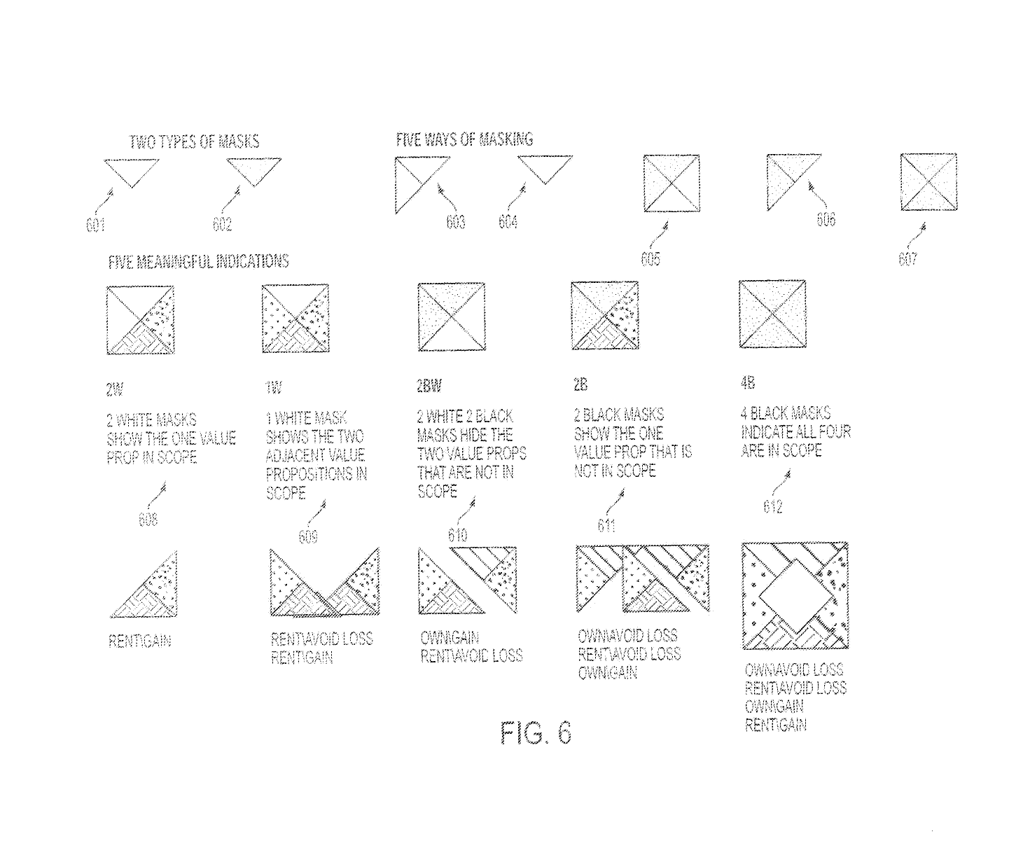

The coding panel may use a combination of masks to encode the value propositions. FIG. 6 illustrates types of masks that may be used to encode value propositions according to an exemplary embodiment. Referring to FIG. 6, the coding panel may use two types of masks according to an exemplary embodiment: a white mask 601 and a black mask 602. The coding panel may use the two types of masks to implement five ways to mask value propositions: two white masks 603, one white mask 604, two white masks and two black masks 605, one black mask 606, and four black masks 607. The meaning of each type of masking is explained in FIG. 6. Two white masks show the one value proposition that applies. In example 608, the rent/gain proposition is indicated by applying two white masks to the upper (own) and left (avoid loss) quadrants, leaving the rent and gain quadrants visible. In example 609, one white mask is used to identify two adjacent value propositions that are applicable. In this example, one white mask is applied to the top quadrant (own) indicating that the rent/avoid loss and rent/gain value propositions apply. In example 610, two white masks are applied to the bottom (rent) and right (gain) quadrants, and two black masks are applied to the top (own) and left (avoid loss) quadrants. This masking configuration hides the two value propositions that are not applicable. In other words, the own/avoid loss and rent/gain propositions do not apply, leaving the own/gain and rent/avoid loss as the applicable value propositions. In example 611, two black masks are applied to the upper (own) and left (avoid loss) quadrants, leaving visible the one value proposition that does not apply. That is, the own/avoid loss, rent/avoid loss, and own/gain propositions apply. In example 612, four black masks are applied to all four quadrants, indicating that all four propositions (own/avoid loss, own/gain, rent/avoid loss, rent/gain) apply.

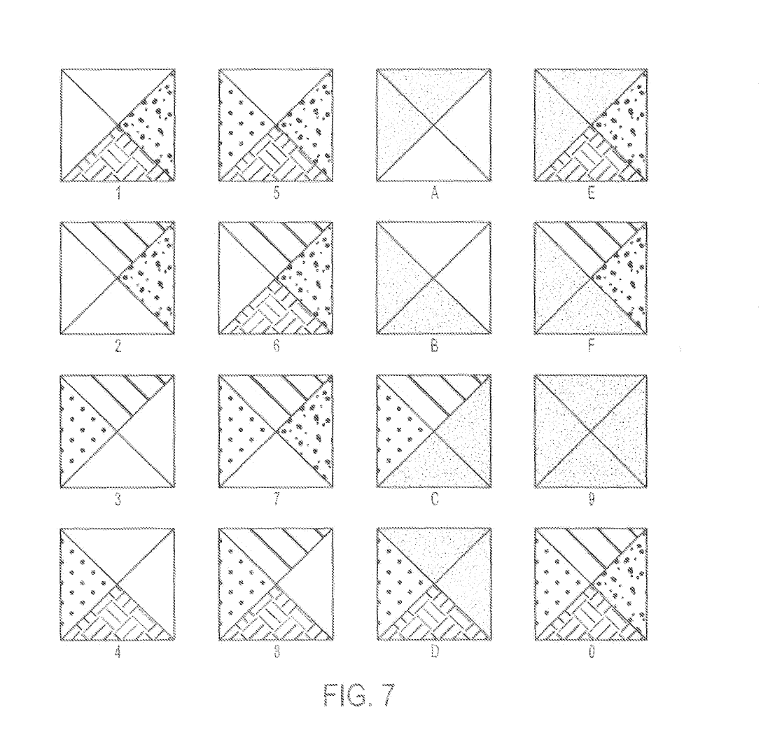

FIG. 7 shows all of the possible masking scenarios that could be used for a given cell in the coding panel according to an exemplary embodiment. As shown in FIG. 7, there may be 16 different encoding possibilities, which may be referenced by a single hexadecimal digit or other alphanumeric or symbolic representation.

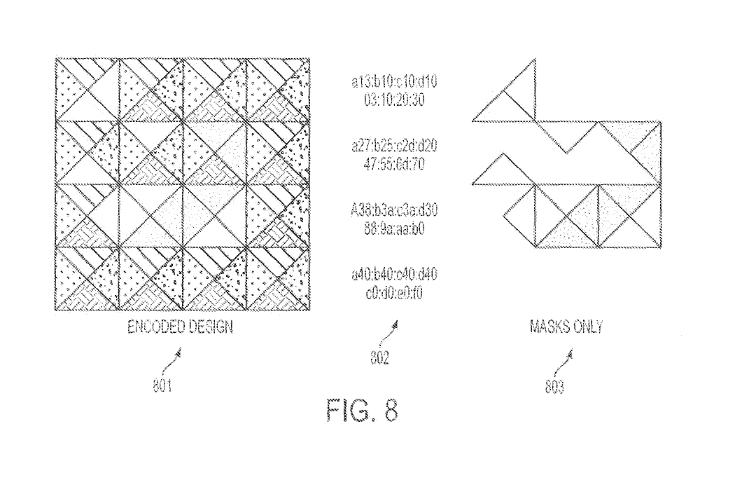

FIG. 8 shows an example of an encoded design according to an exemplary embodiment. Encoded design 801 is an encoded design in which masks have been applied to indicate the value propositions associated with each market space in the coding panel. The hexadecimal representation 802 further encodes the design based on the hexadecimal digits assigned to the masking configurations, as shown in FIG. 7. For example, the top left market space in encoded design 801 is assigned the hexadecimal digit 3 in FIG. 7. In addition, each of the 16 market spaces in encoded design 801 may be assigned one hexadecimal digit 0 through f. Therefore, the hexadecimal representation for the top-left market space may be 03, with ‘0’ representing the position of the market space and ‘3’ representing the masking configuration. The encoded design may also be represented by a ‘masks-only’ configuration 803 in which only the masks that have been applied are shown.

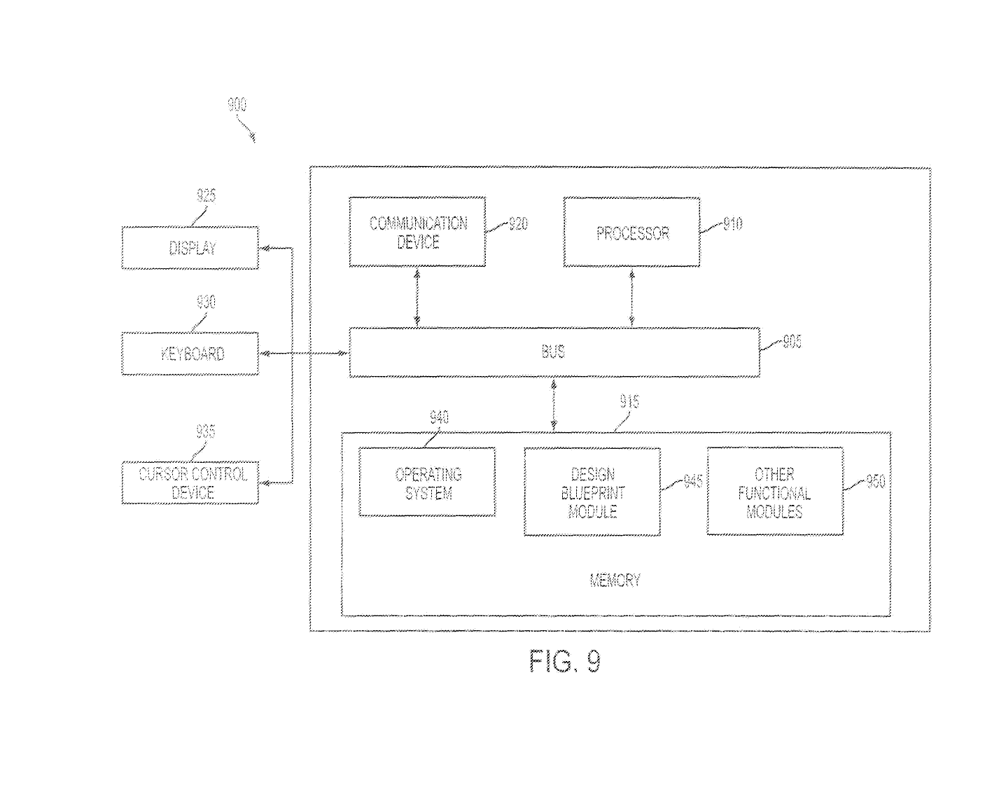

FIG. 9 is a block diagram of a system for implementing the unfold canvas and fold canvas described above. Referring to FIG. 9, a system 900 is illustrating for developing design blueprints for service offerings, according to an exemplary embodiment. System 900 may include a bus 905 or other communication mechanism for communicating information, and a processor 910 coupled to bus 905 for processing information. Processor 910 may be any type of general or specific purpose processor, including a central processing unit (CPU) or application specific integrated circuit (ASIC). System 900 may further include a memory 915 for storing information and instructions to be executed by processor 910. Memory 915 can include any combination of random access memory (RAM), read only memory (ROM), flash memory, cache, static storage such as a magnetic or optical disk, or any other types of non-transitory computer-readable media or combinations thereof. Additionally, system 900 may include a communication device 920, such as a wireless network interface card, to provide access to a network.

Non-transitory computer-readable media may be any available media that can be accessed by processor 910 and may include both volatile and non-volatile media, removable and non-removable media, and communication media. Communication media may include computer-readable instructions, data structures, program modules or other data in a modulated data signal such as a carrier wave or other transport mechanism and includes any information delivery media.

Processor 910 may be coupled via bus 905 to a display 925, such as a Liquid Crystal Display (“LCD”), for displaying information to a user. A keyboard 930 and a cursor control device 935, such as a computer mouse, may be coupled to bus 905 to enable a user to interface with system 900.

In one exemplary embodiment, memory 915 may store software modules that provide functionality when executed by processor 910. The modules may include an operating system 940 for system 900. The modules may further include a design blueprint module 945 that is configured to facilitate development of design blueprints for service offerings. System 900 may include one or more additional functional modules 950 that include additional functionality.

One skilled in the art will appreciate that a “system” could be embodied as a personal computer, a server, a console, a personal digital assistant (PDA), a cell phone, a tablet computing device, or any other suitable computing device, or combination of devices. Presenting the above-described functions as being performed by a “system” is not intended to limit the scope of the present invention in any way, but is intended to provide one example of many exemplary embodiments. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Although a few exemplary embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A system for developing a design of a service to be provided to a customer or procured from a service provider, the system comprising:
a first canvas comprising a first plurality of elements that define one or more needs for a service, the first plurality of elements arranged in a first array;
a second canvas comprising a second plurality of elements that define a solution that fulfills the one or more needs for the service, the second plurality of elements arranged in a second array;
wherein the elements in the first array of elements are related by a first contiguous logic loop in which one or more elements in the first array of elements are inputs to one or more other elements in the first array of elements;
wherein the elements in the second array of elements are related by a second contiguous logic loop in which one or more elements in the second array of elements are inputs to one or more other elements in the second array of elements; and
wherein an end of the first contiguous logic loop corresponds to a beginning of the second contiguous logic loop; and
wherein the first contiguous logic loop and the second contiguous logic loop are symmetrical with respect to each other.

2. The system of claim 1, wherein the first array of elements and second array of elements are each arranged in a 4×4 array;
wherein the first contiguous logic loop begins at an upper left element of the first array and ends at a lower right element of the first array; and
wherein the second contiguous logic loop begins at a lower right element of the second array and ends at an upper left element of the second array.

3. The system of claim 1, wherein the system permits input information to be posted to at least one element of the first canvas or the second canvas;
wherein the input information comprises one or more of text data, image data, video data, audio data, audio-visual data, hand-written notes, Uniform Resource Locator (URL) addresses, and data from social media applications.

4. The system of claim 3, wherein the first canvas is associated with a first account and the second canvas is associated with a second account, such that the first canvas and the second canvas are configured to receive input information via the first and second accounts, respectively.

5. The system of claim 4, wherein each function of the first canvas and the second canvas comprises an identifier; and
wherein input information containing one or more identifiers is associated with one or more corresponding elements based on the one or more identifiers of the input information.

6. The system of claim 3, wherein the first canvas comprises:
a story board that permits a user to enter a narrative relating to the one or more needs for the service;
wherein the story board parses the narrative and assigns portions of the narrative to the relevant elements in the first canvas.

7. The system of claim 3, further comprising:
an encoder that generates an encoded representation of a design of at least one of (1) the one or more needs for the service and (2) the solution that fulfills the one or more needs for the service, based on the input information posted to the at least one element of the first canvas or the second canvas;
wherein the encoder identifies one or more nouns corresponding to assets or resources that will be used by the solution, and identifies verbs corresponding to uses for the assets or resources in the solution.

8. The system of claim 7, wherein the nouns are grouped into four vertical columns and the verbs are grouped into four horizontal columns to form a 4×4 grid.

9. The system of claim 8, wherein for each row-column intersection in the 4×4 grid the encoder defines value propositions by classifying the nouns based on whether the noun is an asset owned by the customer or a resource rented from the service provider, and whether the use signified by the verb in relation to the noun will avoid loss or affect gain for the customer from use of the solution.

10. The system of claim 9, wherein in each row-column intersection in the 4×4 grid, a value proposition is represented as a geometric shape divided into four quadrants representing owned assets or resources, rented assets or resources, avoided loss, and affected gain, respectively.

11. The system of claim 3, wherein input information posted to a first element that is an input to a second element causes the second element to be updated based on the input information posted to the first element.

12. The system of claim 3, wherein the input information comprises feedback information from a solution that has already been provided to the customer in order to update the first or second canvas.

13. The system of claim 2, wherein the system performs an integrity verification by comparing the upper left element of the first canvas and the upper left element of the second canvas.

14. The system of claim 4, wherein the first and second canvases each comprise a unique identifier.

15. The system of claim 4, wherein the first and second canvases can communicate with each other via the first and second accounts.

16. The system of claim 7, wherein the encoded representation comprises at least one of a color-coded pattern and an alpha-numeric coding.

17. The system of claim 7, further comprising:
the system performing at least one of characterizing, classifying, and cataloging the design based on the encoded representation.

18. The system of claim 1, wherein each element of first canvas and second canvas comprises a checklist that directs or guides the user to complete an associated design function; and
wherein checking or unchecking an item on a checklist triggers an alert, notification, or action for an associated checklist in a different element of the first canvas or second canvas.

19. The system of claim 1, wherein the system generates a set of task lists based on the elements of the first and second canvases, said set of task lists comprising tasks to be completed to implement the design of the service.

20. The system of claim 19, wherein the system generates a file that can be imported or ready by project management software that permits a user to begin planning and scheduling tasks to be completed to implement the design of the service.

21. A method for developing a design of a service to be provided to a customer or procured from a service provider, the method comprising:
generating a first canvas comprising a first plurality of elements that define one or more needs for a service, the first plurality of elements arranged in a first array;
generating a second canvas comprising a second plurality of elements that define a solution that fulfills the one or more needs for the service, the second plurality of elements arranged in a second array;
wherein the elements in the first array of elements are related by a first contiguous logic loop in which one or more elements in the first array of elements are inputs to one or more other elements in the first array of elements;
wherein the elements in the second array of elements are related by a second contiguous logic loop in which one or more elements in the second array of elements are inputs to one or more other elements in the second array of elements;
wherein an end of the first contiguous logic loop corresponds to a beginning of the second contiguous logic loop; and
wherein the first contiguous logic loop and the second contiguous logic loop are symmetrical with respect to each other.

22. The method of claim 21, wherein the first array of elements and second array of elements are each arranged in a 4×4 array;
wherein the first contiguous logic loop begins at an upper left element of the first array and ends at a lower right element of the first array; and
wherein the second contiguous logic loop begins at a lower right element of the second array and ends at an upper left element of the second array.

23. The method of claim 21, further comprising:
posting input information to at least one element of the first canvas or the second canvas;
wherein the input information comprises one or more of text data, image data, video data, audio data, audio-visual data, hand-written notes, Uniform Resource Locator (URL) addresses, and data from social media applications.

24. The method of claim 23, wherein the first canvas is associated with a first account and the second canvas is associated with a second account, such that the first canvas and the second canvas are configured to receive input information via the first and second accounts, respectively.

25. The method of claim 24, wherein each element of the first canvas and the second canvas includes an identifier; the method further comprising:
associating input information containing one or more identifiers with one or more corresponding elements based on the one or more identifiers of the input information.

26. The method of claim 23, further comprising:
receiving a narrative from a user relating to the one or more needs for the service;
parsing the narrative and assigning portions of the narrative to one or more relevant elements in the first canvas.

27. The method of claim 23, further comprising:
generating an encoded representation of a design of at least one of (1) the one or more needs for the service and (2) the solution that fulfills the one or more needs for the service, based on the input information posted to the at least one element of the first canvas or the second canvas;
wherein the encoding component identifies one or more nouns corresponding to assets or resources that will be used by the solution, and identifies verbs corresponding to treatment of the assets or resources in the solution.

28. The method of claim 27, wherein the nouns are grouped into four vertical columns and the verbs are grouped into four horizontal columns to form a 4×4 grid.

29. The method of claim 28, further comprising:
defining, for each row-column intersection in the 4×4 grid, value propositions by classifying the nouns based on whether the noun is an asset owned by the customer or a resource rented from the service provider, and whether the treatment signified by the verb in relation to the noun will avoid loss or affect gain for the customer from use of the solution.

30. The method of claim 29, wherein, in each row-column intersection in the 4×4 grid, a value proposition is represented as a geometric shape divided into four quadrants representing owned assets or resources, rented assets or resources, avoided loss, and affected gain, respectively.

31. The method of claim 23, wherein input information posted to a first element that is an input to a second element causes the second element to be updated based on the input information posted to the first element.

32. The method of claim 23, wherein the input information comprises feedback information from a solution that has already been provided to the customer in order to update the first or second canvas.

33. The method of claim 23, further comprising:
performing an integrity verification by comparing the upper left element of the first canvas and the upper left element of the second canvas.

34. The method of claim 24, wherein the first and second canvases each comprise a unique identifier.

35. The method of claim 24, wherein the first and second canvases can communicate with each other via the first and second accounts.

36. The method of claim 27, wherein the encoded representation comprises at least one of a color-coded pattern and an alpha-numeric coding.

37. The method of claim 27, further comprising:
at least one of characterizing, classifying, and cataloging the design based on the encoded representation.
